(19) United States
(12) Patent Application Publication
(10) Pub. No.: US 2025/0388188 A1
(43) Pub. Date: Dec. 25, 2025

(54) MACRO-MICRO GESTURE DETECTION

(71) Applicant: Ford Global Technologies, LLC, Dearborn, MI (US)

(72) Inventors: Pietro Buttolo, Dearborn Heights, MI (US); Ivan Vukovic, Birmingham, MI (US); Sathyanarayana Chary Palakonda, Northville, MI (US); Jean de Dieu Mutangana, Detroit, MI (US); Sanketh Venkatesh Prasad, Bloomington, IL (US); Bradley G. Hochrein, Dexter, MI (US)

(21) Appl. No.: 18/753,529

(22) Filed: Jun. 25, 2024

(51) Int. Cl. B60R 25/24; B60R 25/30; G06F 3/01; G06F 3/0346

(52) U.S. Cl. CPC B60R 25/24; B60R 25/30; G06F 3/017; G06F 3/0346; B60R 2325/205

(57) ABSTRACT

Macro-micro gesture detection is provided. Performance of a macro portion of a macro-micro gesture is detected by a mobile device, using phone-as-a-key (PaaK) sensors of a vehicle, the macro-micro gesture requesting invocation of a function of the vehicle. Using one or more inertial measurement unit (IMU) sensors of the mobile device, performance of a micro portion of the macro-micro gesture is detected. Arbitrating is performed to validate that the function of the vehicle is to be performed in view of performance of both the micro portion and the macro portion. The function of the vehicle is invoked responsive to the validation being successful.

### TECHNICAL FIELD

Aspects of the disclosure relate to macro-micro gesture detection using phone-as-a-key (PaaK) ranging in combination with inertial measurement unit (IMU) sensors of a mobile device.

### BACKGROUND

Some vehicles may be unlocked or started with a digital key. A digital key, sometimes implemented with a smartphone, e.g., PaaK, relies on communication between a mobile device such as a smartphone and the vehicle. When an application is activated on the mobile device and the mobile device is held at a particular location relative to the vehicle, such as next to the door handle, the vehicle unlocks the doors. A digital key may communicate with the vehicle using Bluetooth®, near field communication (NFC), and/or ultrawide band (UWB).

An IMU is an electronic device that measures and reports a body's specific force, angular rate, and sometimes the orientation of the body, using a combination of accelerometers, gyroscopes, and sometimes magnetometers.

### SUMMARY

In one or more illustrative examples, a method for macro-micro gesture detection, includes detecting, using phone-as-a-key (PaaK) sensors of a vehicle, performance of a macro portion of a macro-micro gesture by a mobile device, the macro-micro gesture requesting invocation of a function of the vehicle; detecting, using one or more inertial measurement unit (IMU) sensors of the mobile device, performance of a micro portion of the macro-micro gesture; arbitrating to validate that the function of the vehicle is to be performed in view of performance of both the micro portion and the macro portion; and invoking the function of the vehicle responsive to the validation being successful.

In one or more illustrative examples, a system for system for macro-micro gesture detection, includes a transceiver of a vehicle; a plurality of UWB anchors; and a controller, in communication with the transceiver and the plurality of UWB anchors. The controller is configured to detect, using the UWB anchors sensors of the vehicle, performance of a macro portion of a macro-micro gesture by a mobile device, the macro-micro gesture requesting invocation of a function of the vehicle, detect a micro portion of the macro-micro gesture using one or more inertial measurement unit (IMU) sensors of the mobile device, arbitrate, by the vehicle, to validate that the function of the vehicle is to be performed in view of performance of both the micro portion and the macro portion, and invoke the function of the vehicle responsive to the validation being successful.

In one or more illustrative examples, a non-transitory computer readable medium comprising instructions that, when executed by a controller of a vehicle in communication with a transceiver and a plurality of UWB anchors, causes the controller to perform operations including to detect, using the UWB anchors sensors of the vehicle, performance of a macro portion of a macro-micro gesture by a mobile device, the macro-micro gesture requesting invocation of a function of the vehicle; detect a micro portion of the macro-micro gesture using one or more inertial measurement unit (IMU) sensors of the mobile device; arbitrate, by the vehicle, to validate that the function of the vehicle is to be performed in view of performance of both the micro portion and the macro portion; and invoke the function of the vehicle responsive to the validation being successful.

### BRIEF DESCRIPTION OF THE DRAWINGS

FIG. 1 illustrates an example system including a vehicle implementing macro-micro gesture detection;

FIG. 2 illustrates an example of the mobile device beginning to approach the vehicle;

FIG. 3A illustrates an example of the PaaK system of the vehicle triangulating the mobile device;

FIG. 3B illustrates an alternate example of the mobile device triangulating its own location using a feed of UWB data from the vehicle;

FIG. 4A illustrates an example of the PaaK system of the vehicle sending a macro gesture detection message to the mobile device;

FIG. 4B illustrates an example of the mobile device detecting the macro gesture using the feeds of UWB data;

FIG. 5 illustrates an example of a micro gesture being performed using the mobile device;

FIG. 6A illustrates an example of the mobile device sending a micro gesture detection message to the vehicle;

FIG. 6B illustrates an example of the vehicle detecting the micro gesture using the IMU data;

FIG. 7 illustrates an example of the vehicle performing the function based on the combined macro-micro gesture being performed;

FIG. 8 illustrates an example of a mobile device leaving the vicinity of the vehicle;

FIG. 9 illustrates an example process for performing macro-micro gesture detection using the vehicle in combination with the mobile device; and

FIG. 10 illustrates an example computing device for use in implementing macro-micro gesture detection.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Gaining access to a vehicle trunk, especially after a long session of shopping can be difficult. This may be especially so for a vehicle that is not equipped with hands-free operation. Yet, with hands-free technology there may be a trade-off between convenience and frustration, when the technology doesn't activate as expected or activates in an unintended situation. For instance, when returning home, it may be desirable for the vehicle liftgate to close when access is no longer required, but not too soon in case there are more items to unload.

There are other scenarios where it may be helpful to trigger vehicle functionality. One way to achieve this is through interacting with an app on our phone. However, such an approach typically requires the use of both hands which is not ideal in many situations. Another solution is to use voice or camera activation. However, voice requires additional hardware in the vehicle or the use of the microphone on the phone, which may be difficult as the user may not always be in a location that allows for use of voice detection. Camera detection can also be difficult to implement due to its higher power requirements. Capacitive and ultrasonic systems may be used, but such systems can be ineffective at distinguishing between wanted vs. unintended activations. Radar can also be used, but requires increased cost and power.

UWB is a radio access technology (RAT) that is becoming prevalent as part of a digital key system, such as PaaK, either alone or in combination with Bluetooth Low Energy (BLE) to accurately locate the user device and to lower the risk of playback attacks. An improved approach may analyze a user's gesture by leveraging the PaaK features to accurately locate an authorized smart-phone by triangulating time-of-flight from multiple receivers. This solution offers the benefits of detecting a user gesture without any additional hardware. It can also guarantee a robust detection, since the motion detection is deterministic in the bounds of the UWB triangulation accuracy.

Nevertheless, the quality of gesture detection is limited by the UWB sampling rate. A gesture will typically complete in less than a second. Some hand motions will take even less. At a sampling rate of around 100 msec, this means that only 5 to 10 samples might be available to decide. Additionally, such an approach tracks the position of the phone. Because with UWB resolution is a few centimeters, small gestures may be undetectable. That requires the user to perform wide sweeping motion, generating a trajectory distinctively different from someone typically walking nearby the vehicle (such as a sweeping motion of the arm holding the phone overhead and down). Such a requirement may be difficult or undesirable.

By taking advantage of the combination of the vehicle PaaK UWB location services, plus the smartphone internal sensors and actuators, a macro-micro gesture detection may be performed. This approach may consider the gesture to be recognized as a combination of macro motion detected by the PaaK features in combination with micro motion detected by the IMU features of the smartphone or other user mobile device. This may allow for a vocabulary of multiple gestures to be composed. Each gesture can be tailored to the specific task and context. Each gesture can also be predefined or created by the user.

The macro component may be captured using the UWB location of the mobile device. For example, the PaaK location service of the vehicle may detect an approaching trajectory, as the user moves closer to the vehicle (e.g., towards the liftgate). In another example, the vehicle may send the UWB location data to the mobile device, and the mobile device may detect the approaching trajectory. In either case, this may be considered the macro part of the macro-micro gesture.

The micro component may be captured using the IMU sensors of the mobile device. In an example, at a predefined distance, a request may be sent to the mobile device to start detecting gestures locally using its IMU. The IMU can detect a very broad spectrum of micro gestures, such as sweeping motions, tracked using a combination of accelerometer and gyroscope signals, tilting/twisting motions, using just the gyroscope, or sharp shocks/pulses, using just the accelerometer. In another example, the mobile device may provide to the vehicle a feed of data from the one or more inertial measurement unit (IMU) sensors of the mobile device (and/or of a wearable device in communication with the mobile device), and the performance of the micro portion of the macro-micro gesture may be detected by the vehicle. This may be considered the micro part of the macro-micro gesture.

An arbitration may be performed to ensure that both the macro portion and the micro portion of the macro-micro gesture are performed. This arbitration may be performed by the mobile device, and/or by the vehicle. If the timing of the macro portion and the micro portion is too remove, or if the action otherwise cannot be performed (e.g., if the door is blocked from opening), feedback may be provided to the user the action cannot be performed. Further aspects of the disclosure are discussed in detail herein.

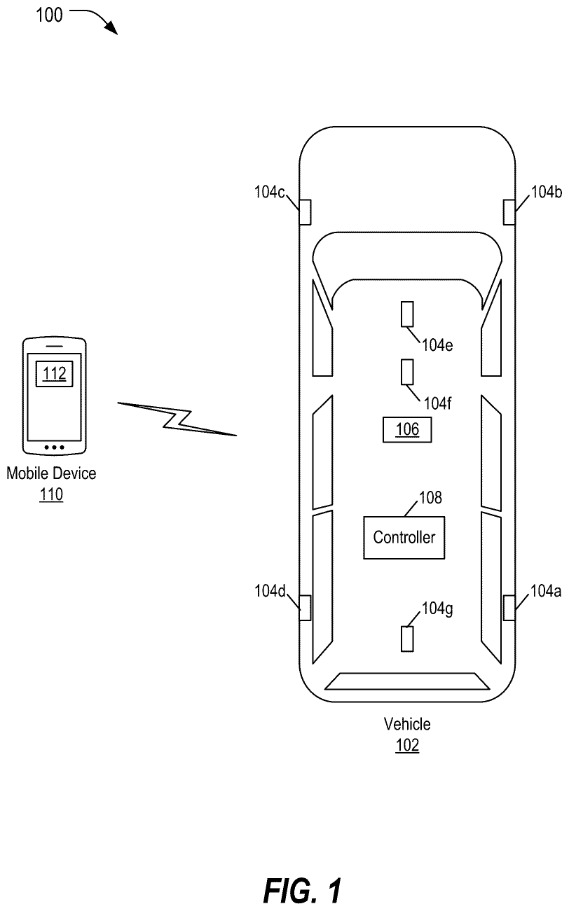

FIG. 1 illustrates an example system 100 including a vehicle 102 implementing macro-micro gesture detection. As shown, the vehicle 102 includes a plurality of UWB anchors 104, a transceiver 106, and a controller 108. The system 100 may be used to track the position of mobile devices 110. The mobile devices 110 may also include IMUs 112, which may be leveraged to allow the vehicle 102 to understand aspects of the user's behavior.

Referring more specifically to FIG. 1, the vehicle 102 may be any passenger or commercial automobile such as a car, a truck, a sport utility vehicle, a crossover, a van, a minivan, a taxi, a bus, etc. The vehicle 102 may include various types of automobile, crossover utility vehicle (CUV), sport utility vehicle (SUV), truck, recreational vehicle, motorcycle, boat, plane or other mobile machine for transporting people or goods. Such vehicles 102 may be human-driven or autonomous. In many cases, the vehicle 102 may be powered by a gasoline, diesel, or hydrogen engine. As another possibility, the vehicle 102 may be a battery electric vehicle powered by one or more electric motors. As a further possibility, the vehicle 102 may be a hybrid electric vehicle powered by both an engine and one or more electric motors, such as a series hybrid electric vehicle, a parallel hybrid electrical vehicle, or a parallel/series hybrid electric vehicle.

The UWB anchors 104 communicate wirelessly with the mobile device 110 using radio waves. The UWB anchors 104 use an ultra-wideband signal, e.g., a signal with a low energy level spread over a large range of the radio spectrum. The Federal Communications Commission and the International Telecommunications Union Radiocommunication Sector define ultra-wideband as an antenna transmission for which emitted signal bandwidth exceeds the lesser of 500 MHz or 20% of the arithmetic center frequency. The UWB anchors 104 may use any suitable modulation method, e.g., orthogonal frequency-division multiplexing (OFDM), phase-shift keying (PSK), pulse-position modulation (PPM), etc.

To enable robust user localization, the vehicle 102 may be equipped with UWB responders that are strategically positioned in the interior of the vehicle 102 and within the body structure to provide UWB network coverage of the environment in and around the vehicle 102, i.e., where the mobile device 110 of the user may be located. Depending on the physical design and shape of the vehicle 102, some of the UWB anchors 104 may be placed inside the body walls of the vehicle 102 (e.g., four respectively placed near or/at each corner of the front and rear bumpers of the vehicle 102), center console (e.g., between the driver and passenger seats) and inside the roof (e.g., near the front center, near the rear center).

As shown in the example of FIG. 1, seven UWB anchors 104 are shown. These include a first UWB anchor 104a, a second UWB anchor 104b, a third UWB anchor 104c, a fourth UWB anchor 104d, a fifth UWB anchor 104e, a sixth UWB anchor 104f, and a seventh UWB anchor 104g. The UWB anchors 104 are spaced apart from each other, e.g., spread over the vehicle 102, to increase the ability to distinguish a location when used for trilateration. For example, four of the UWB anchors 104 may be located at respective corners of the vehicle 102 to maximize the horizontal spread of the UWB anchors 104, and the remaining three UWB anchors 104 may be located internally to a footprint of the vehicle 102 at different heights than the corner-mounted UWB anchors 104 to provide a vertical spread. To perform trilateration, computation of the intersection of three or more circles or spheres, may provide the location of the detected device.

The transceiver 106 may be adapted to transmit signals wirelessly through a different communication protocol than what is used by the UWB anchors 104, such as cellular, Bluetooth®, BLE, WiFi, Institute of Electrical and Electronics Engineer (IEEE) standard 802.11a/b/g/p, cellular-V2X (CV2X), Dedicated Short-Range Communications (DSRC), etc. The transceiver 106 is adapted to communicate using a protocol that is also used by the mobile device 110. In particular, the transceiver 106 may use BLE. The transceiver 106 may be one device or may include a separate transmitter and receiver.

The controller 108 may be a microprocessor-based computing device, e.g., a generic computing device including a processor and a memory, an electronic controller or the like, a field-programmable gate array (FPGA), an application-specific integrated circuit (ASIC), a combination of the foregoing, etc. Typically, a hardware description language such as VHDL (VHSIC (Very High Speed Integrated Circuit) Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. The controller 108 can thus include a processor, a memory, etc. The memory of the controller 108 can include media for storing instructions executable by the processor as well as for electronically storing data and/or databases, and/or the controller 108 can include structures such as the foregoing by which programming is provided. The controller 108 can be multiple computers coupled together.

The controller 108 may transmit and receive data through a communications network such as a controller area network (CAN) bus, Ethernet, WiFi, Local Interconnect Network (LIN), onboard diagnostics connector (OBD-II), and/or by any other wired or wireless communications network. The controller 108 may be communicatively coupled to the UWB anchors 104, a transceiver 106, and other components via the communications network. The controller 108 may localize the position of the mobile device 110 using trilateration, based on the distance information collected between each of the UWB anchors 104 and the mobile device 110.

The UWB anchors 104 and the transceiver 106 may communicate with at least one mobile device 110. The mobile devices 110 may include portable computing devices such as smart key fobs; mobile phones, e.g., smartphones; wearable devices, e.g., smartwatches, headsets, etc.; tablets; smart tools, etc. The mobile devices 110 are computing devices including respective processors and respective memories. The mobile devices 110 may be owned and carried by respective persons who may be operators and/or owners of the vehicle 102.

To perform the trilateration, a computation of the intersection of three or more circles or spheres may be performed. The UWB anchors 104 may be configured to transmit and receive signals (within signal power thresholds) over UWB channel frequencies (e.g., UWB channel 9 (7.737-8.236 GHz) to Channel 5 (6.240-6.739 GHz) or other possible channels that are adopted by the UWB standard). Under ideal radio frequency (RF) conditions, e.g., when the mobile device 110 is located within the line of sight (LOS), three UWB anchors 104 may be sufficient in locating the mobile device 110, i.e., the initiator, and thereby enabling trilateration-based localization of the user through responder-to-initiator distance ranging. However, because of the possibility of less favorable RF conditions, data from more than three UWB anchors 104 may be utilized by the controller 108 to ensure there is adequate wireless UWB coverage to locate the mobile device 110.

In addition to for use in PaaK, the controller 108 may also use the UWB anchors 104 to perform various presence features. These presence features may include intrusion detection or child presence detection. This may be accomplished through measurement of wireless channel characteristics between interior transmit and receive UWB anchors 104.

For example, channel impulse response (CIR) may be used between the UWB anchors 104 to characterize the wireless environment of the vehicle 102. The CIR may describe how a wireless channel responds to an impulse signal, which is a very short and high-energy signal. The CIR captures the amplitude, phase, and delay of the multipath components that are sent from a transmitter and received by a receiver after reflecting, refracting, or scattering within the environment. By observing the multipath components of the CIR caused by scattering at target objects, movement of humans within the vehicle 102 may be detected.

The IMU 112 of the mobile device 110 may include various devices configured to capture movements of the user of the mobile device 110. These IMUs 112 may include one or more of accelerometers, gyroscopes, and/or magnetometers. The IMU 112 may be used for gesture detection, for example, by tracking the movements of the user of the mobile device 110.

A gesture to be recognized may be detected using a combination of macro motion detected by the PaaK features (e.g., the UWB anchors 104 and transceiver 106) and micro motion detected by the IMU 112 features of the mobile device 110.

The macro component of the macro-micro gesture may be captured using the PaaK location of the mobile device 110. In an example, the PaaK location services of the vehicle 102 may be used to detect an approaching trajectory, as the user moves closer to the vehicle 102, toward the liftgate, for example. In another example, the PaaK location services of the vehicle 102 may be used to detect a retreating trajectory, as the user moves away from the vehicle 102. These determinations may be performed by the controller 108 using data from the UWB anchors 104, and/or by the mobile device 110 receiving a feed of location data from the UWB anchors 104.

The micro component of the macro-micro gesture may be captured using the IMU 112 features of the mobile device 110. In an example, responsive to detection of the macro gesture, the vehicle 102 may send a request to the mobile device 110 to begin detecting the micro gesture locally using its IMU 112. In another example, the mobile device 110 may begin detecting the micro gesture locally (e.g., responsive to detection of proximity of the vehicle 102 via detection of messaging from the UWB anchors 104 and/or transceiver 106 of the vehicle 102) regardless of detection of the macro gesture by the vehicle 102. In yet another example, the mobile device 110 may send a feed of the IMU 112 data to the vehicle 102 and the vehicle 102 may determine whether the micro gesture is performed. The data from the one or more IMUs 112 may be used to detect a spectrum of micro gestures, such as sweeping motions, tracked using a combination of accelerometer and gyroscope signals, tilting/twisting motions, using just the gyroscope, or sharp shocks/pulses, using just the accelerometer.

If the macro gesture and the micro gesture of the macro-micro gesture are both detected (and the macro-micro gesture is associated with a function of the vehicle 102) then the corresponding function of the vehicle 102 may be activated. The vehicle 102 and/or the mobile device 110 may perform an arbitration based on the occurrence of the macro gesture and the micro gesture. For example, the vehicle 102 and/or the mobile device 110 may confirm that the macro gesture and the micro gesture are both performed within a predefined time period. In some examples, the order may be required, such that the macro gesture must be performed first, and then the micro gesture. In other examples, the order may be reversed, such that the micro gesture must be performed first and then the macro gesture. In still other examples, the macro gesture and the micro gesture may be performed in any order and/or at least partially overlapping in time within the predefined time period. The vehicle 102 may invoke the function if the timing is correct and if the function is able to be activated. The vehicle 102 may also provide feedback to the user if the action cannot be performed (e.g., if an obstacle is detected in the path of a door being requested to be opened).

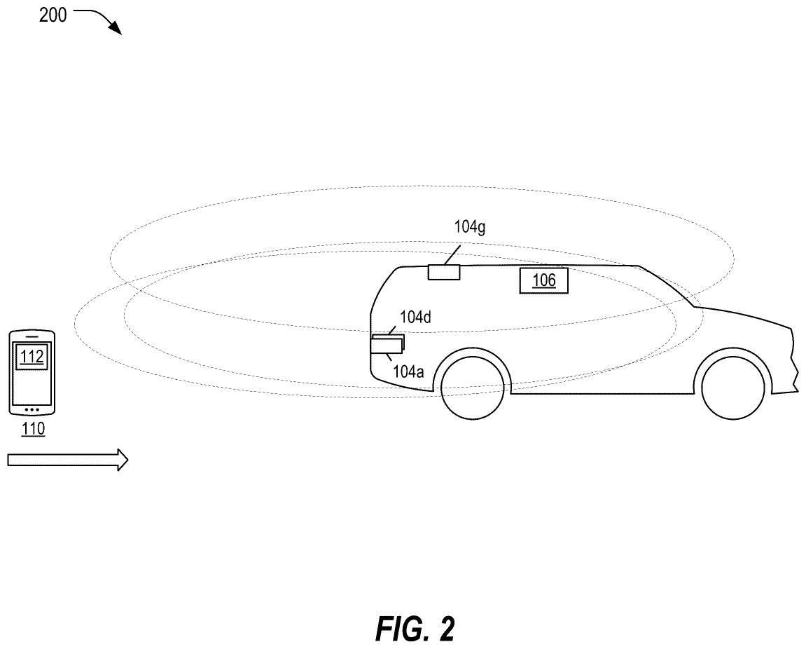

FIG. 2 illustrates an example 200 of the mobile device 110 beginning to approach the vehicle 102. For example, a user may be carrying the mobile device 110 in a bag, purse, pocket, or hand while approaching the vehicle 102. The transceiver 106 may be used to track the mobile device 110 when the user is still relatively far from the vehicle 102 (e.g., more than twenty meters in an example). This monitoring of user distance may be performed based on Bluetooth received signal strength indicator (RSSI), in an example. Responsive to the user's device being detected by the transceiver 106, the controller 108 may activate the UWB anchors 104 (e.g., as shown UWB anchors 104a, 104d, 104g). As can be seen, the mobile device 110, as shown, is presently out of range of the UWB anchors 104 of the PaaK system of the vehicle 102. The vehicle 102 may begin tracking the user's position using the UWB anchors 104 as the vehicle 102 may be aware that the mobile device 110 is in the vicinity and a distance measurement would be useful. In another example, the vehicle 102 may inyoite a feed of the UWB data to the mobile device 110, and the mobile device 110 may begin tracking the user's position using the UWB anchors 104.

The vehicle 102 and/or the mobile device 110 may be configured to use the PaaK system to detect performance of a macro gesture. The macro gesture may comprise a sequence of locations of the mobile device 110 over time which may be compared to and matched to a predefined sequence of locations of the mobile device 110 over time. If the sequences are a match, then the macro gesture may be considered to be performed. The macro gesture may include various gestures and/or movements that are detectable by the PaaK system of the vehicle 102, such as kicking, punching, swaying, stepping forwards and backwards, jumping, etc.

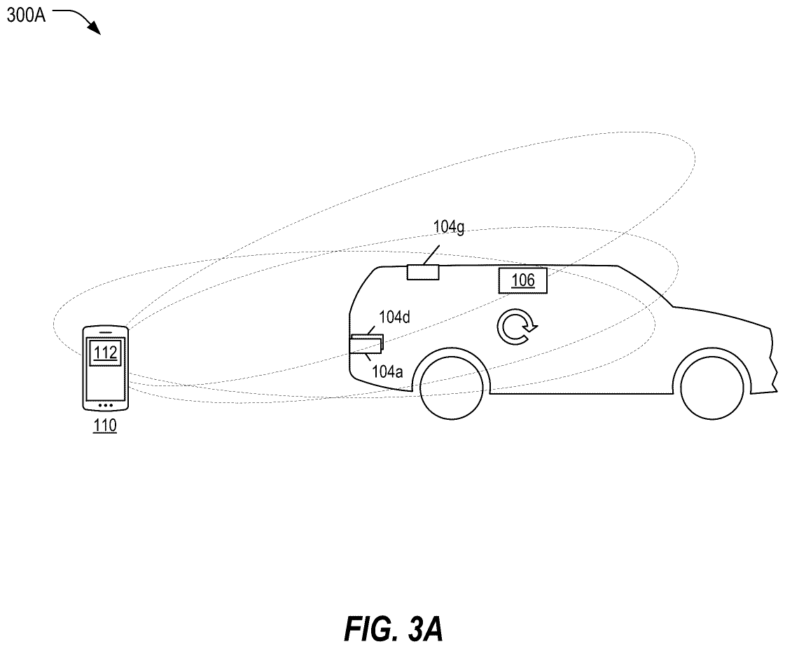

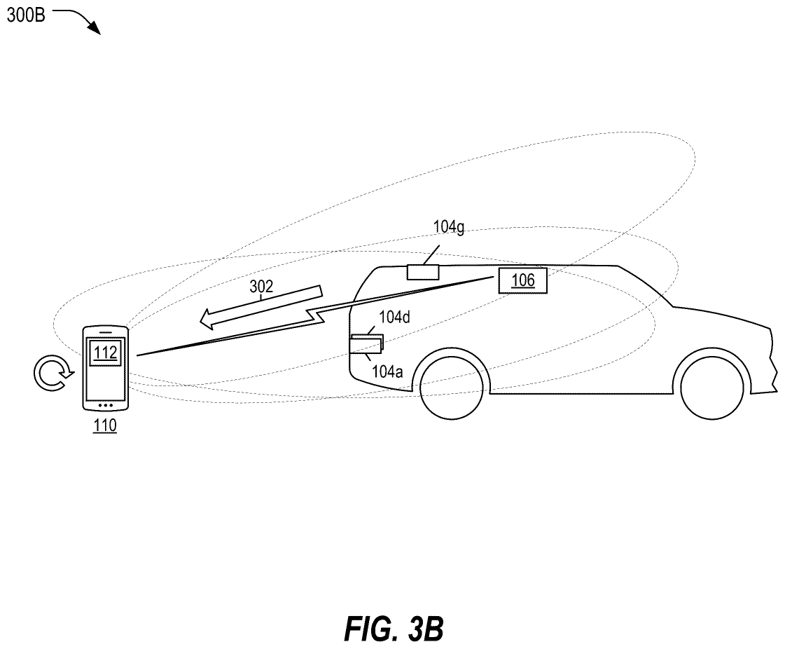

FIG. 3A illustrates an example 300A of the PaaK system of the vehicle 102 triangulating the mobile device 110. As noted above, the user carrying the mobile device 110 may have approached the vehicle 102 and stopped. At this point, the controller 108 may localize the position of the mobile device 110 using trilateration, based on the distance information collected between each of the UWB anchors 104 and the mobile device 110. For instance, the vehicle 102 may use three or four of the closest UWB anchors 104 to the mobile device 110 to perform the localization.

FIG. 3B illustrates an alternate example 300B of the mobile device 110 triangulating its own location using a feed 302 of UWB data from the vehicle 102. As noted above, the user carrying the mobile device 110 may have approached the vehicle 102 and stopped. At this point, the controller 108 may initiate sending raw data from the vehicle 102 to the mobile device 110 to allow the mobile device 110 to localize its position using trilateration. This feed 302 may be sent via the transceiver 106 in an example. Or, the mobile device 110 math analyze data from the UWB anchors 104 directly, based on its communication with the UWB anchors 104. In these variations, the mobile device 110 may triangulate its own position based on the distance information collected between each of the UWB anchors 104 and the mobile device 110.

The macro gesture may be for the vehicle 102 and/or mobile device 110 to determine that the mobile device 110 of the user has stopped moving and is now in position in proximity to a feature of the vehicle 102. The threshold for determining the cessation of movement may be within a predefined movement boundary to allow for some movement, as the stationary end of movement portion of the macro-micro gesture is only one component of the overall gesture and would not trigger the function by itself. The function to be activated is a liftgate in the illustrated example but could be any other function of the vehicle 102, such as a door, tailgate, light, speaker, winch, window, etc. that may be activatable via gesture input.

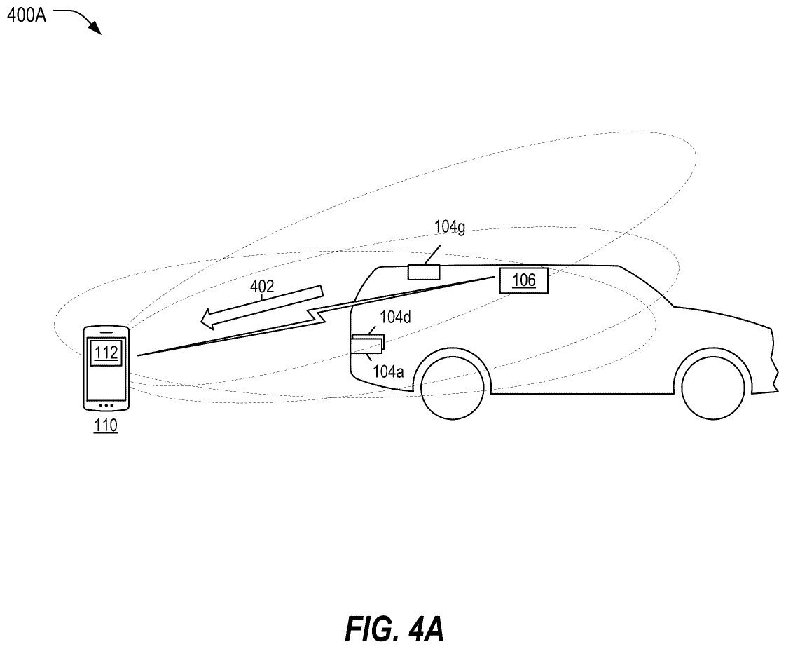

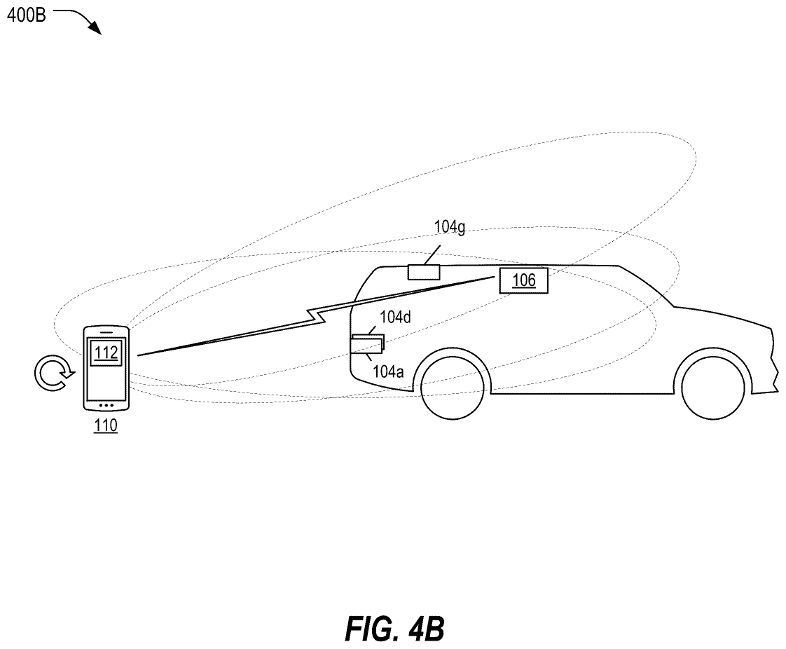

FIG. 4A illustrates an example 400A of the PaaK system of the vehicle 102 sending a macro gesture detection message 402 to the mobile device 110. The sending of the macro gesture detection message 402 may be performed responsive to detection of the macro gesture by the vehicle 102. Significantly, instead of activating the feature, responsive to determining the occurrence of the macro gesture, the vehicle 102 may sends the macro gesture detection message 402 to the mobile device 110. In one example, the macro gesture detection message 402 may be sent from the transceiver 106 of the vehicle 102 to the mobile device 110, e.g., via BLUETOOTH or BLE. The macro gesture detection message 402 may be received by the mobile device 110, to cause the mobile device 110 to start detecting the micro portion of the macro-micro gesture.

FIG. 4B illustrates an example 400B of the mobile device 110 detecting the macro gesture using the feeds of UWB data. In such a case, the macro gesture detection message 402 is not sent from the vehicle 102 to the mobile device 110. Instead, the mobile device 110 locally determines that the macro gesture is performed.

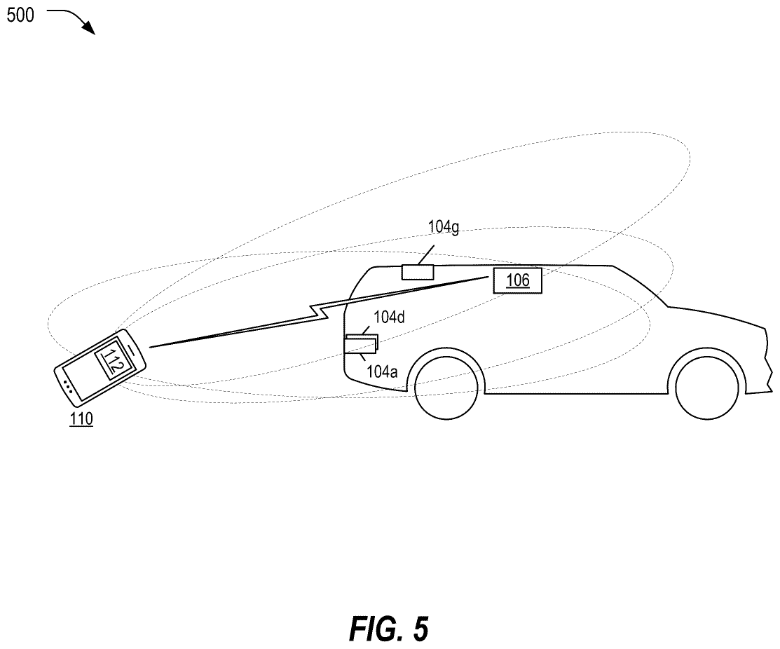

FIG. 5 illustrates an example 500 of a micro gesture being performed using the mobile device 110. This micro gesture detection may be performed to the mobile device 110 by the user, and may be detectable by the one or more IMUs 112 of the mobile device 110. The micro gesture may comprise a sequence of vibrations or other movements of the mobile device 110 over time which may be compared to and matched to a predefined sequence of vibrations or other movements of the mobile device 110 over time. If the sequences are a match, then the micro gesture may be considered to be performed.

It should be noted that the IMUs 112 may be used to detect a very broad spectrum of micro gestures. These may include, as some non-limiting examples, be sweeping motions (e.g., tracked using a combination of accelerometer and gyroscope IMUs 112), tilting/twisting motions (e.g., tracked using just the gyroscope IMU 112), and/or sharp shocks/pulses (e.g., tracked using just the accelerometer IMU 112). As some further examples, the micro gesture could be the user gently tapping their foot on the ground (e.g., to produce pulses of vibration), tapping the mobile device 110 in the user's pocket with the side of the user's hand, etc. Additionally, or alternately, the mobile device 110 may trigger a tactile notification, e.g., to notify the user that the user can begin to perform the micro gesture to activate the function of the vehicle 102. Additionally, or alternately, the mobile device 110 may leverage IMUs 112 included in other externally-connected devices, such as fitness smart bands of the user.

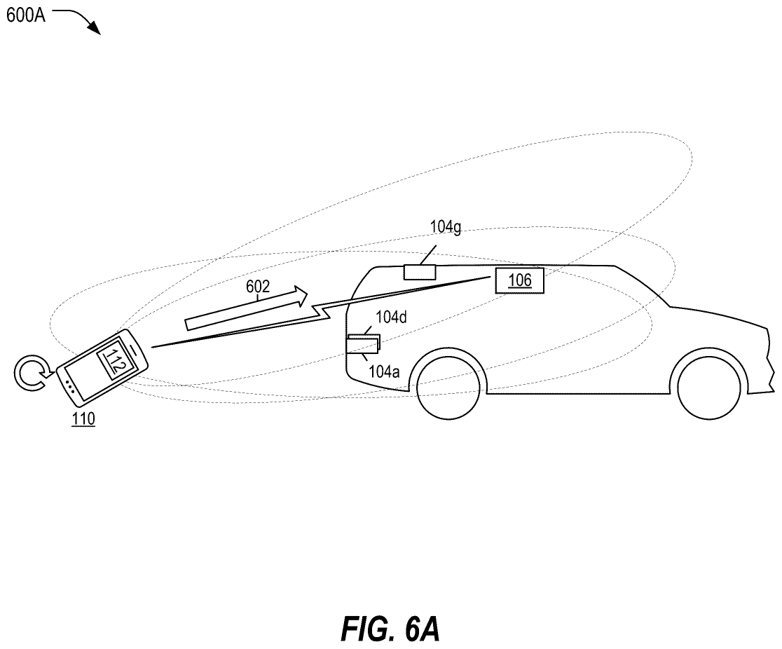

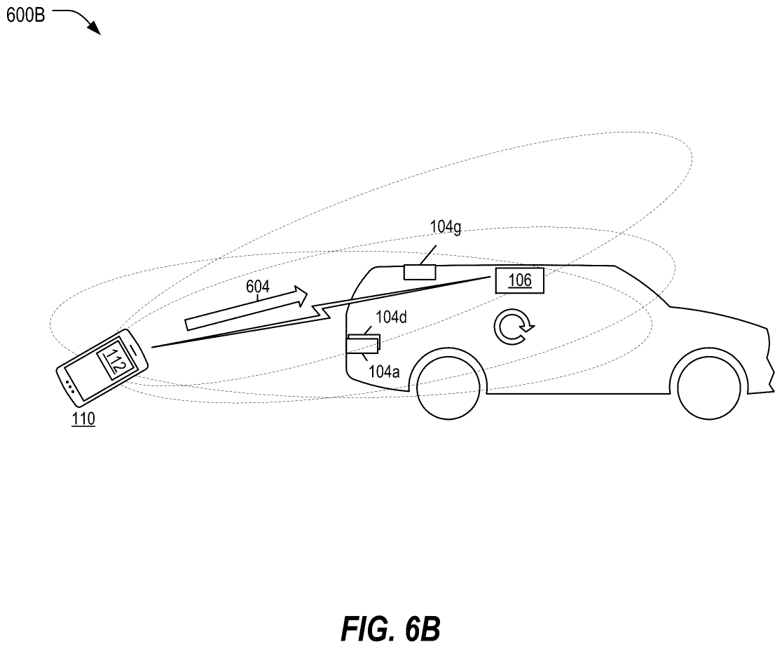

FIG. 6A illustrates an example 600A of the mobile device 110 sending a micro gesture detection message 602 to the vehicle 102. In such an example, the mobile device 102 performs the comparison of the IMU 112 data to the micro gesture. Responsive to the mobile device 110 detecting a valid micro gesture associated with the function of the vehicle 102, the micro gesture detection message 602 may be sent to the vehicle 102 to inform the vehicle 102 of the detection of the micro gesture by the mobile device 110.

FIG. 6B illustrates an example 600B of the vehicle 102 detecting the micro gesture. In this variation, the mobile device 110 sends a feed of IMU data 604 to the vehicle 102, and the macro gesture is detected by the vehicle 102 processing the feed of IMU data 604. In such a case no micro gesture detection message 602 may be sent from the mobile device 110 to the vehicle 102.

Regardless of approach, this valid micro gesture, in combination with the valid macro gesture, may request a corresponding function of the vehicle 102 to be activated.

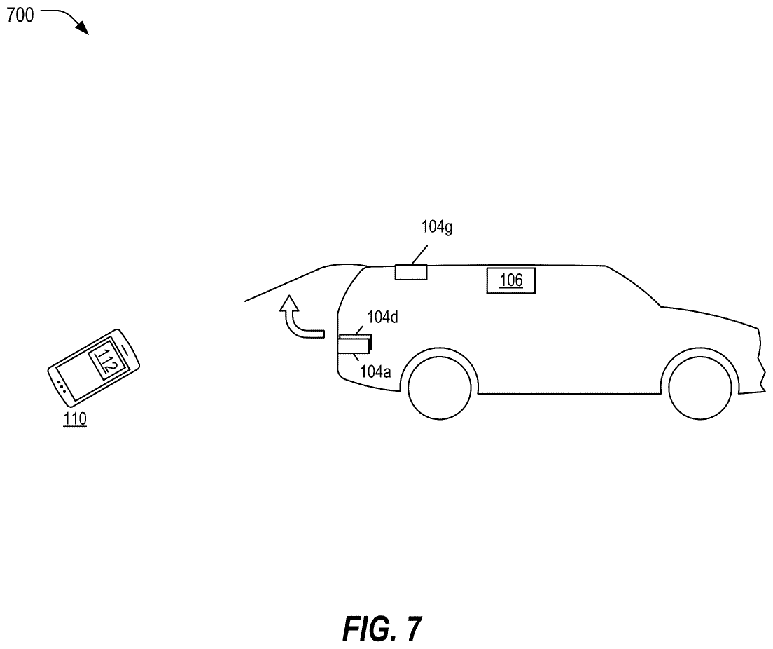

FIG. 7 illustrates an example 700 of the vehicle 102 performing the function based on the combined macro-micro gesture being performed. Responsive to receipt of the micro gesture detection message 602, the vehicle 102 and/or the mobile device 110 may performs an arbitration to determine whether to invoke the feature or provide feedback to the user that the feature cannot be invoked.

In an example, the arbitration may include the vehicle 102 and/or the mobile device 110 confirming that the macro gesture and the micro gesture have been performed within a maximum allowable timeframe. If, for example, the micro gesture is performed too long after the macro gesture, then the micro gesture may not be considered to complete the macro-micro gesture. In another example, the arbitration may include confirming that the requested function is able to be performed. For instance, the sensors of the vehicle 102 may be used to confirm that the tailgate being requested for opening (as shown in FIG. 7) is not blocked by a wall, a car, a person, or some other obstruction that may prevent the function from being performed. Responsive to the arbitration being successful, the vehicle 102 may perform the feature (e.g., invoked by the vehicle 102 responsive to performing the arbitration, responsive to the mobile device 102 requesting the feature based on the mobile device 110 performing the arbitration, etc.). Responsive to the arbitration being unsuccessful, the system 100 may provide feedback to the user that the feature cannot be invoked. As shown, the macro micro gesture is confirmed, and the tailgate is opened.

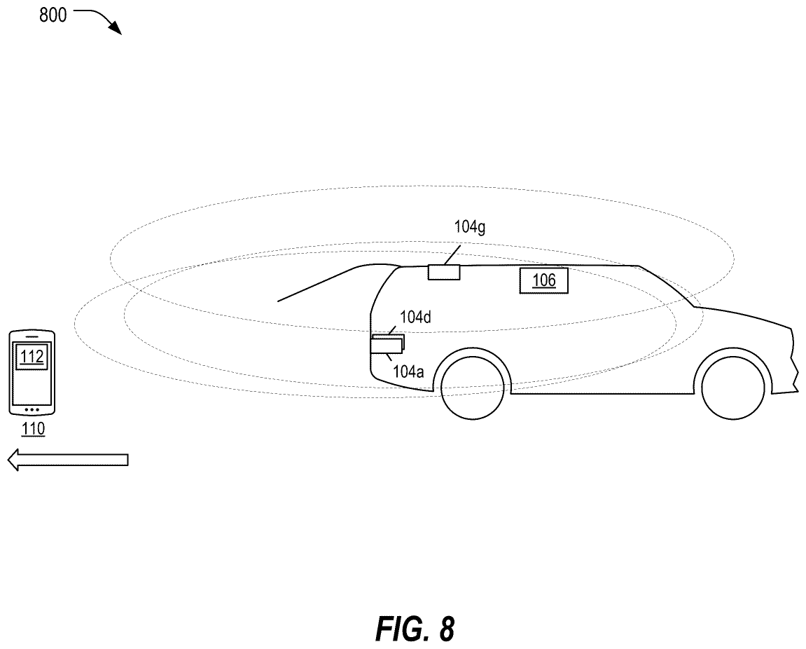

FIG. 8 illustrates an example 800 of a mobile device 110 leaving the vicinity of the vehicle 102. In an example, the PaaK system of vehicle 102 (e.g., the UWB anchors 104 and/or the transceiver 106) may be used by the mobile device 110 and/or the vehicle 102 to detect that the mobile device 110 has changed from a standing or still position nearby the liftgate to moving away from the vehicle 102. Again, this macro gesture is insufficient to decide to auto-close the liftgate yet, as the user might need to return to unload more cargo. Significantly, since a complete macro-micro gesture has not been performed, the liftgate is not automatically closed.

Instead, as noted herein, a second macro gesture detection may be performed using the IMUs 112 (and/or third-party wearable accessory sensors such as smart bands, smart watches, etc.) to detect micro gestures.

Responsive to the micro gesture being detected, such as a double tap performed with the foot or with the side of the hands with phone in pocket, or a quick twist of the wrist to trigger a detection on the smart watch, the arbitration is again performed, and the function may be activated. In an example, if the micro gesture to close the tailgate is received, then the vehicle 102 may ensure that the tailgate is not obstructed to close, and if so, may then activate the close function of the tailgate.

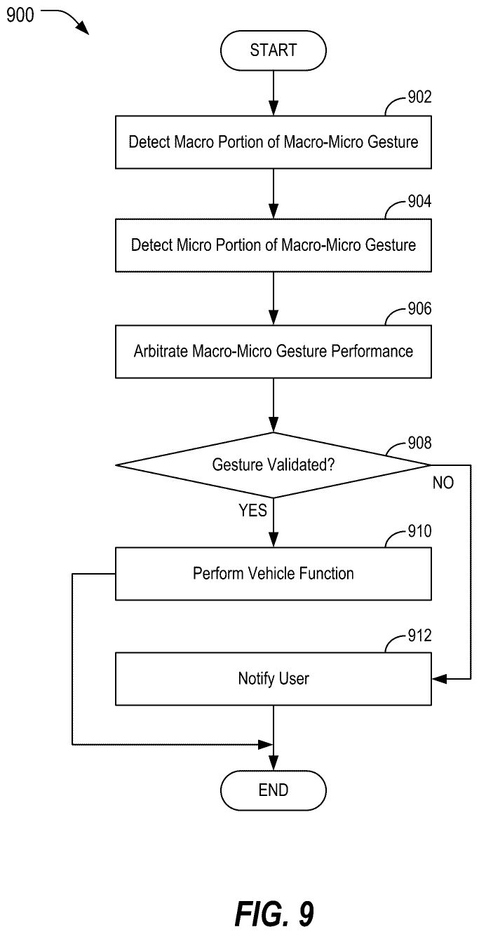

FIG. 9 illustrates an example process 900 for performing macro-micro gesture detection using the vehicle 102 in combination with the mobile device 110. Each macro-micro gesture may be tailored to a specific function. For example, the function to be activated may be any function of the vehicle 102, such as a door, tailgate, lift gate, light, speaker, winch, window, etc. that may be activated via gesture input. Each macro-micro gesture may also be predefined or created by the user.

At operation 902, a macro portion of a macro-micro gesture is detected. In an example, the macro portion is detected using information from UWB anchors 104 of the vehicle 102 to triangulate a location of the mobile device 110 over time and compare the location of the mobile device 110 over time to a predefined macro gesture. The macro gesture may comprise a sequence of locations of the mobile device 110 over time which may be compared to and matched to a predefined sequence of locations of the mobile device 110 over time. In some cases, the detection may be performed on the vehicle 102 (such as shown in FIG. 3A), while in other cases, the detection may be performed by the mobile device 110 (such as shown in FIG. 3B). Regardless, if the sequences are a match, then the macro gesture may be considered to be performed. The macro gesture may include various gestures and/or movements that are detectable by the PaaK system of the vehicle 102, such as kicking, punching, swaying, stepping forwards and backwards, jumping, etc.

At operation 904, a micro portion of a macro-micro gesture is detected. In an example, the micro gesture detection may be performed to the mobile device 110 by the user, and may be detectable by the one or more IMUs 112 of the mobile device 110. The micro gesture may comprise a sequence of vibrations or other movements of the mobile device 110 over time which may be compared to and matched to a predefined sequence of vibrations or other movements of the mobile device 110 over time. If the sequences are a match, then the micro gesture may be considered to be performed. In some cases, the detection may be performed on the mobile device 110 (such as shown in FIG. 6A), while in other cases, the detection may be performed by the vehicle 102 (such as shown in FIG. 6B).

At operation 906, the macro-micro gesture is arbitrated to validate that the function of the vehicle 102 is to be performed. This is done in view of performance of both the micro portion and the macro portion. In an example, the arbitration may include the vehicle 102 confirming that the macro gesture and the micro gesture have been performed within a maximum allowable timeframe. In another example, the arbitration may include the vehicle 102 confirming that the requested function is able to be performed, e.g., that there are no obstacles preventing the function from being performed. The arbitration may be performed by the mobile device 110 and/or by the vehicle 102.

At operation 910, it is determined whether the macro-micro gesture is validated at operation 908. If the gesture is validated, control proceeds to operation 912. Otherwise, control proceeds to operation 914.

At operation 912, the vehicle 102 performs the function of the vehicle 102. In an example, the vehicle 102 having arbitrated the macro-micro gesture invokes the function. In another example, the mobile device 110 having arbitrated the macro-micro gesture sends a message to the vehicle 102 invoking the function. After operation 912, the process 900 ends.

At operation 914, a notification is provided by the mobile device 110. In an example, the notification message may inform the user of the mobile device 110 that the validation was unsuccessful and the function is not being invoked. In an example, the vehicle 102 having arbitrated the macro-micro gesture sends the notification to the mobile device 110 for display. In another example, the mobile device 110 having arbitrated the macro-micro gesture generates the notification for display. After operation 914, the process 900 ends.

Various combinations of the aforementioned techniques may be combined to perform the process 900. In an example, the controller 108, in communication with the transceiver 106 and the plurality of UWB anchors 104 may be configured to detect, by the UWB anchors 104 of the vehicle 102, performance of a macro portion of a macro-micro gesture by a mobile device 110, the macro-micro gesture requesting invocation of a function of the vehicle 102. The transceiver 106 may send to the mobile device 110, a macro gesture detection message 402 requesting that the mobile device 110 monitor for performance of a micro portion of the macro-micro gesture to be detected by the mobile device 110. The controller 108 may receive, from the mobile device 110 to the transceiver 106, responsive to the mobile device 110 detecting the micro portion of the macro-micro gesture vis data from the one or more IMUs 112, a micro gesture detection message 602 indicating the performance of the micro portion of the macro-micro gesture. The controller 108 may arbitrate, for the vehicle 102, to validate that the function of the vehicle 102 is to be performed in view of performance of both the micro portion and the macro portion. The controller 108 may invoke the function of the vehicle 102 responsive to the validation being successful.

In another example, the mobile device 110 may be configured to receive, from the transceiver 106, a feed 302 of UWB data from the vehicle 102 and detect the macro gesture based on the feed 302. The mobile device 110 may further detect the micro portion of the macro-micro gesture vis data from the one or more IMUs 112. The mobile device 110 may perform the arbitration, and may send a message to the controller 108 to invoke the function of the vehicle 102 responsive to the validation being successful. It should be noted that these are only two variations, and various other approaches consistent with the disclosure may be used.

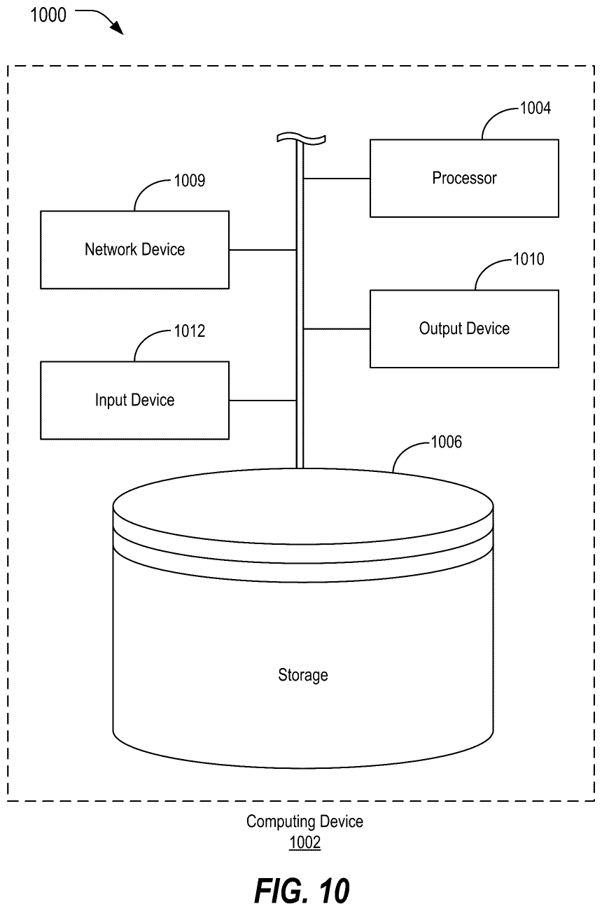

FIG. 10 illustrates an example computing device 1002 for implementing the improved tracking approach to selectively power down various of the UWB anchors 104 to preserve energy of the vehicle 102. Referring to FIG. 8, and with reference to FIGS. 1-9, the vehicle 102, UWB anchors 104, transceiver 106, controller 108, and mobile device 110 may be examples of such computing devices 1002. Computing devices 1002 generally include computer-executable instructions, where the instructions may be executable by one or more computing devices 1002. Computer-executable instructions may be compiled or interpreted from computer programs created using a variety of programming languages and/or technologies, including, without limitation, and either alone or in combination, Java™, C, C++, C#, Visual Basic, JavaScript, Python, JavaScript, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

As shown, the computing device 1002 may include a processor 1004 that is operatively connected to a storage 1006, a network device 1008, an output device 1010, and an input device 812. It should be noted that this is merely an example, and computing devices 1002 with more, fewer, or different components may be used.

The processor 1004 may include one or more integrated circuits that implement the functionality of a central processing unit (CPU) and/or graphics processing unit (GPU). In some examples, the processors 1004 are a system on a chip (SoC) that integrates the functionality of the CPU and GPU. The SoC may optionally include other components such as, for example, the storage 1006 and the network device 1008 into a single integrated device. In other examples, the CPU and GPU are connected to each other via a peripheral connection device such as Peripheral Component Interconnect (PCI) express or another suitable peripheral data connection. In one example, the CPU is a commercially available central processing device that implements an instruction set such as one of the x86, ARM, Power, or Microprocessor without Interlocked Pipeline Stages (MIPS) instruction set families.

Regardless of the specifics, during operation the processor 1004 executes stored program instructions that are retrieved from the storage 1006. The stored program instructions, accordingly, include software that controls the operation of the processors 1004 to perform the operations described herein. The storage 1006 may include both non-volatile memory and volatile memory devices. The non-volatile memory includes solid-state memories, such as Not AND (NAND) flash memory, magnetic and optical storage media, or any other suitable data storage device that retains data when the system is deactivated or loses electrical power. The volatile memory includes static and dynamic random access memory (RAM) that stores program instructions and data during operation of the system 100.

The GPU may include hardware and software for display of at least two-dimensional (2D) and optionally three-dimensional (3D) graphics to the output device 1010. The output device 1010 may include a graphical or visual display device, such as an electronic display screen, projector, printer, or any other suitable device that reproduces a graphical display. As another example, the output device 1010 may include an audio device, such as a loudspeaker or headphone. As yet a further example, the output device 1010 may include a tactile device, such as a mechanically raiseable device that may, in an example, be configured to display braille or another physical output that may be touched to provide information to a user.

An input device 1012 may include any of various devices that enable the computing device 1002 to receive control input from users. Examples of suitable input devices 1012 that receive human interface inputs may include keyboards, mice, trackballs, touchscreens, microphones, graphics tablets, and the like.

The network devices 1008 may each include any of various devices that enable the described components to send and/or receive data from external devices over networks. Examples of suitable network devices 1008 include an Ethernet interface, a Wi-Fi transceiver, a cellular transceiver, or a BLUETOOTH or BLE transceiver, or other network adapter or peripheral interconnection device that receives data from another computer or external data storage device, which can be useful for receiving large sets of data in an efficient manner.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A method for macro-micro gesture detection, comprising:
detecting, using phone-as-a-key (PaaK) sensors of a vehicle, performance of a macro portion of a macro-micro gesture by a mobile device, the macro-micro gesture requesting invocation of a function of the vehicle;
detecting, using one or more inertial measurement unit (IMU) sensors of the mobile device, performance of a micro portion of the macro-micro gesture;
arbitrating to validate that the function of the vehicle is to be performed in view of performance of both the micro portion and the macro portion; and
invoking the function of the vehicle responsive to the validation being successful.

2. The method of claim 1, further comprising:
receiving, to the vehicle from the mobile device, a feed of data from the one or more IMU sensors of the mobile device; and
detecting the performance of the micro portion of the macro-micro gesture by the vehicle.

3. The method of claim 1, further comprising:
detecting the performance of the micro portion of the macro-micro gesture by the mobile device; and
responsive to the mobile device detecting the micro portion of the macro-micro gesture, sending, to the vehicle from the mobile device, a micro gesture detection message.

4. The method of claim 1, further comprising:
sending, from the vehicle to the mobile device, data from the PaaK sensors of the vehicle; and
detecting the performance of the macro portion of the macro-micro gesture by the mobile device.

5. The method of claim 1, further comprising:
detecting the performance of the macro portion of the macro-micro gesture by the vehicle; and
responsive to the vehicle detecting the macro portion of the macro-micro gesture, sending, by the vehicle to the mobile device, a macro gesture detection message.

6. The method of claim 1, wherein the arbitrating includes confirming that the micro portion and the macro portion occur both within a predefined time period.

7. The method of claim 1, wherein the detecting the performance of the macro portion and the detecting the performance of the macro portion are performed in a concurrent or overlapping manner.

8. The method of claim 1, wherein the arbitrating includes sending a notification message to the mobile device to inform that the validation was unsuccessful and the function is not being invoked, responsive to the macro portion not occurring within a predefined time period.

9. The method of claim 1, wherein the arbitrating includes sending a notification message to the mobile device to inform that the function is not being invoked, responsive to sensors of the vehicle indicating that the function cannot be performed.

10. The method of claim 1, wherein the micro portion is detected at least in part using one or more IMU sensors of wearables in wireless communication with the mobile device.

11. The method of claim 1, further comprising sending, from the vehicle to the mobile device, a definition of the micro portion of the macro-micro gesture customized to the mobile device.

12. The method of claim 1, further comprising maintaining, by the mobile device, a definition of the micro portion of the macro-micro gesture to be detected.

13. The method of claim 1, further comprising:
detecting, by the PaaK sensors of the vehicle, the performance of the macro portion of the macro-micro gesture by the mobile device, the macro-micro gesture requesting the invocation of the function of the vehicle,
sending, from a transceiver of the vehicle to the mobile device, a macro gesture detection message requesting that the mobile device monitor for the performance of the micro portion of the macro-micro gesture to be detected by the mobile device,
receiving, from the mobile device to the transceiver, responsive to the mobile device detecting the micro portion of the macro-micro gesture, a micro gesture detection message indicating the performance of the micro portion of the macro-micro gesture,
arbitrating, by the vehicle, to validate that the function of the vehicle is to be performed in view of performance of both the micro portion and the macro portion, and
invoking the function of the vehicle responsive to the validation being successful.

14. A system for macro-micro gesture detection, comprising:
a transceiver of a vehicle;
a plurality of ultrawide band (UWB) anchors; and
a controller, in communication with the transceiver and the plurality of UWB anchors, configured to:
detect, using the UWB anchors, performance of a macro portion of a macro-micro gesture by a mobile device, the macro-micro gesture requesting invocation of a function of the vehicle,
detect a micro portion of the macro-micro gesture using one or more inertial measurement unit (IMU) sensors of the mobile device,
arbitrate, by the vehicle, to validate that the function of the vehicle is to be performed in view of performance of both the micro portion and the macro portion, and
invoke the function of the vehicle responsive to the validation being successful.

15. The system of claim 14, wherein the controller is further configured to one or more of:
detect the performance of the micro portion of the macro-micro gesture by the vehicle based on a feed of data from the one or more IMU sensors received from the mobile device; and/or
detect the performance of the micro portion of the macro-micro gesture by receiving, from the mobile device, a micro gesture detection message indicating the performance of the micro portion of the macro-micro gesture as detected by the mobile device.

16. The system of claim 14, wherein the controller is further configured to one or more of:
send, to the mobile device, data from the UWB anchors of the vehicle to cause the mobile device to detect the performance of the macro portion of the macro-micro gesture; and/or
detect the performance of the macro portion of the macro-micro gesture by the controller analyzing the data from the UWB anchors.

17. The system of claim 14, wherein one or more of:
the arbitration includes confirming that the micro portion and the macro portion occur both within a predefined time period; and/or
to detect the performance of the macro portion and to detect the performance of the macro portion are performed in a concurrent or overlapping manner.

18. The system of claim 14, wherein the arbitration includes one or more of to:
send a notification message to be displayed by the mobile device to inform that the validation was unsuccessful and the function is not being invoked, responsive to the macro portion not occurring within a predefined time period; and/or
the mobile device generating and displaying the notification message to inform that the validation was unsuccessful and the function is not being invoked.

19. The system of claim 14, wherein the controller is further configured to send, from the vehicle to the mobile device, a definition of the micro portion of the macro-micro gesture customized to the mobile device.

20. A non-transitory computer readable medium comprising instructions that, when executed by a controller of a vehicle in communication with a transceiver and a plurality of UWB anchors, causes the controller to perform operations including to:
detect, using the UWB anchors of the vehicle, performance of a macro portion of a macro-micro gesture by a mobile device, the macro-micro gesture requesting invocation of a function of the vehicle;
detect a micro portion of the macro-micro gesture using one or more inertial measurement unit (IMU) sensors of the mobile device;
arbitrate, by the vehicle, to validate that the function of the vehicle is to be performed in view of performance of both the micro portion and the macro portion; and
invoke the function of the vehicle responsive to the validation being successful.
